(19) United States
(12) Patent Application Publication
(10) Pub. No.: US 2017/0071299 A1
(43) Pub. Date: Mar. 16, 2017

(54) Gemstone Cut

(71) Applicant: Kaushal Shah, New York, NY (US)

(72) Inventor: Kaushal Shah, New York, NY (US)

(21) Appl. No.: 15/267,749

(22) Filed: Sep. 16, 2016

Related U.S. Application Data
(60) Provisional application No. 62/219,344, filed on Sep. 16, 2015.

(51) Int. Cl. A44C 17/00; B28D 5/00

(52) U.S. Cl. CPC A44C 17/00; B28D 5/00

(57) ABSTRACT

A gemstone cut. The gemstone cut includes sixty one facets such that a crown has twenty four facets and a table facet, a girdle has twelve facets, and the pavilion has twenty four facets.

### CROSS REFERENCE TO RELATED APPLICATION

This application claims the benefit of U.S. Provisional Application No. 62/219,344 filed on Sep. 16, 2015. The above identified patent application is herein incorporated by reference in its entirety to provide continuity of disclosure.

### BACKGROUND OF THE INVENTION

### FIELD OF THE INVENTION

The present invention relates to the field of cut gemstones. More specifically, the present invention provides a gemstone comprising 61 cut facets arranged to generate a hexagonal star pattern along several edges of the facets when exposed to light.

One measure of the quality of a diamond or other gemstone is related to the cut of the gemstone. The better the cut of a gemstone, the higher the quality of light reflected and thus an increase in the brilliance. Gemstones are generally cut with facets forming the exterior surface of the stone. Facets cut in a gemstone may also form a geometric figure or design, whereby the number and position of the facets capture and reflect light to create illumination effects. Facets are usually cut in the crown and in the pavilion of the stone and the surfaces of the facets are then polished to obtain the brilliance, dispersion and/or scintillation desired from the gem.

Devices have been disclosed in the known art that relate to gemstones and gemstone cuts. These include devices that have been patented and published in patent application publications. These devices in the known art have several known drawbacks. For example, a gemstone having a large number of facets may be difficult to produce or a gemstone having a small number of facets may fail to obtain desirable brilliance and scintillation.

The present invention provides a gemstone that comprises a gemstone having 61 facets. Many commercially available diamonds typically have about 58 facets. The increased number of facets and position of these facets of the gemstone of the present invention produces a cut stone that is more desirable.

In light of the devices disclosed in the known art, it is submitted that the present invention substantially diverges in design elements from the devices in the known art and consequently it is clear that there is a need in the art for an improvement to existing gemstones and gemstone cuts. In this regard the instant invention substantially fulfills these needs.

### SUMMARY OF THE INVENTION

In view of the foregoing disadvantages inherent in the known types of gemstones and gemstone cuts now present in the art, the present invention provides a new gemstone wherein the same can be utilized for providing desirable brilliance and scintillation for the user when exposed to light.

It is therefore an object of the present invention to provide a new and improved gemstone having 61 facets that capture and reflect light.

It is another object of the present invention to provide a gemstone with improved characteristics such that a star is visible when viewed from at least one particular angle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an illustrative side view of the gemstone and associated general structure.

FIG. 2 shows an overhead view of the gemstone.

FIG. 3 shows a bottom view of the gemstone.

FIG. 4 shows a detailed side view of the gemstone, including the gemstone crown, girdle, and pavilion.

FIG. 5 shows a plan view showing the effect achieved by the unique cut of the gemstone of the present invention when viewed down through the crown in a table up position under a magnifying device

### DETAILED DESCRIPTION OF THE INVENTION

Reference is made herein to the attached drawings. Like reference numerals are used throughout the drawings to depict like or similar elements of the gemstone. The figures are intended for representative purposes only and should not be considered to be limiting in any respect.

It should be noted that the gemstone of the present invention can be a precious stone or a semi-precious stone, but in the preferred embodiment, the gemstone is a diamond. Thus, the type of gemstone should not be used to restrict the scope of the present invention. Furthermore, the specific parameters (e.g., depths, heights, ratios, and angles) are used for illustrative purposes only and should not be used to limit the scope of the present invention. Additionally, the shape of the gemstone in the figures corresponding to the specification and the preferred embodiment are for illustrative purposes only, and one skilled in the art can envision using other shapes (e.g., an oval shape, a marquis shape, etc.).

It is appreciated that many angles are provided herein and are exemplary of a preferred embodiment of the present invention. The angles and shapes may deviate or change a small amount without departing from the broad aspects of the present invention. For example, it may be preferred to change the shape, slope and/or azimuth slightly when cutting a particular stone so as to specifically include or exclude certain features of the stone to determine what is included and/or excluded from the finished gemstone.

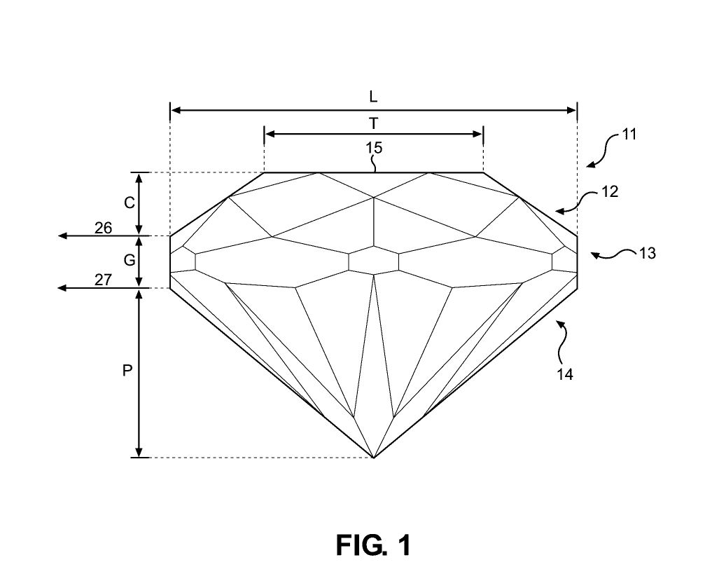

Referring to FIG. 1, there is shown an illustrative side view of the gemstone and associated general structure. The basic structure of the gemstone 11 is divided into three sections: a crown 12 which forms the upper section of the gemstone 11, a pavilion 14 which forms the lower section of the diamond, and a girdle 13 which forms the rim separating the crown 12 from the pavilion 14. The crown comprises a table facet 15 (henceforth called “table”) that is disposed along a horizontal plane. Facets are disposed on each of the crown 12, the girdle 13, and the pavilion 14, and each facet is arranged concentrically around the gemstone 11. The girdle 14 includes an upper girdle plane 26 and a lower girdle plane 27, wherein the upper girdle plane 26 and a lower girdle plane 27 are parallel to a horizontal plane, and parallel to the table 15.

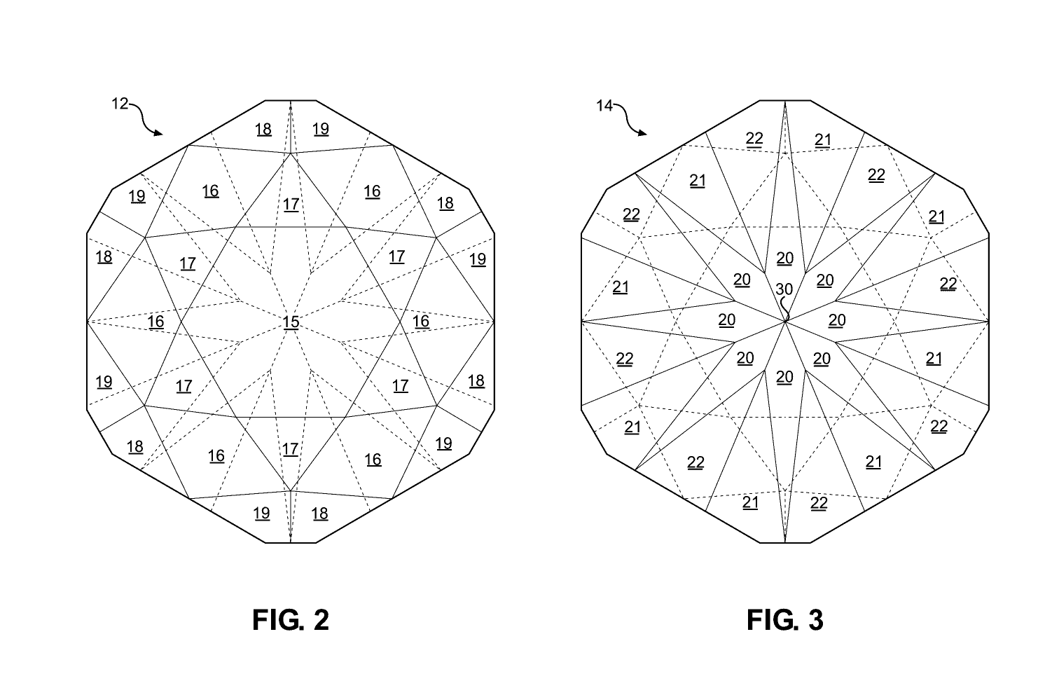

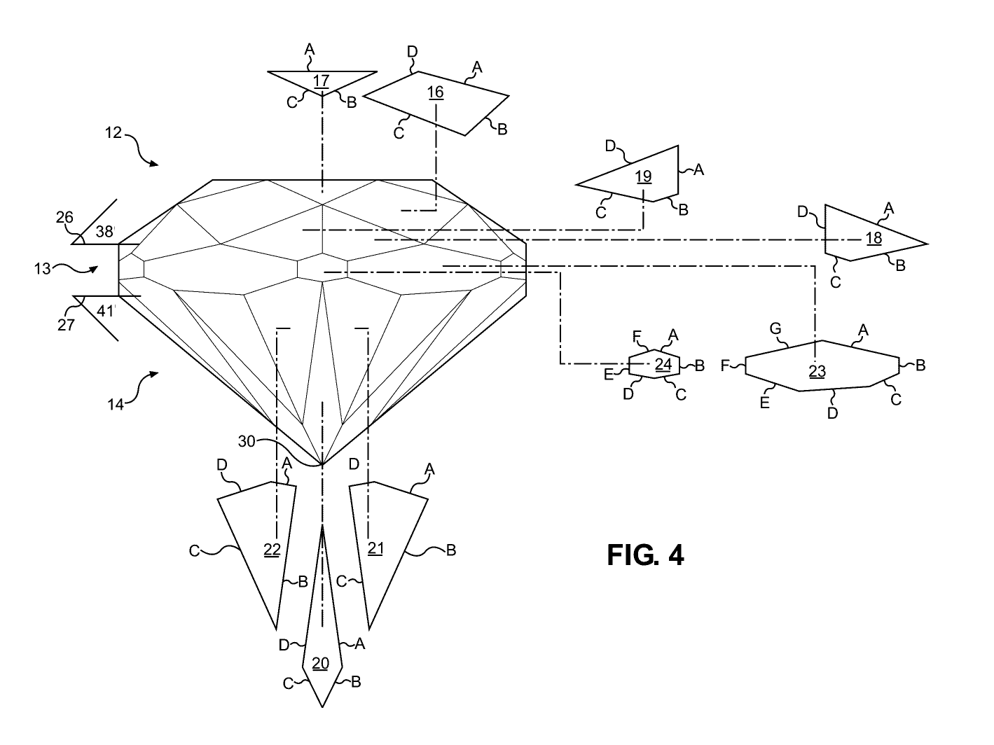

Referring to FIGS. 2 and 3, there is shown an overhead view of the gemstone, and a bottom view of the gemstone, respectfully. The gemstone 11 comprises sixty-one facets. Referring to FIG. 4, there is shown a detailed side view of the gemstone, including the gemstone crown, girdle, and pavilion.

Turning specifically to FIGS. 2 and 4, the crown 12 comprises a plurality of facets 16, 17, 18, 19 disposed around a table 15. In a preferred embodiment, the crown 12 comprises twenty four facets 16, 17, 18, 19 disposed around the table 15, wherein the table 15 has six sides. The table 15 is disposed along a horizontal plane. The crown 12 further comprises a plurality of crown main facets 16, a plurality of crown star facets 17, a plurality of right crown kite facets 18, and a plurality of left crown kite facets 19. The crown main facets 16 are located equidistant around the table 15 and each crown main facet 16 includes a vertex (a point formed by at least two sides) along a side of the table 15. In a preferred embodiment, the plurality of crown main facets 16 comprise six quadrilateral crown main facets having sides a, b, c, d, arranged around the table 15, each of the crown main facets 16 having an upper vertex formed between sides a, d along the table 15 and a lower vertex, formed between sides b, c along the upper girdle plane 26, and arranged at an angle between 37 degrees and 39 degrees with respect to the upper girdle plane 26.

The plurality of crown star facets 17 are located equidistant around the table 15. In a preferred embodiment, the plurality of crown star facets 17 comprising six triangular crown star facets having sides a, b, c, d, e, f, each crown star facet 17 arranged adjacent to one of sides of the table 15, and arranged between adjacent crown main facets 16.

The plurality of right crown kite facets 18 and the plurality of left crown kite facets 19 are located equidistant around the table 15. In a preferred embodiment, there are six quadrilateral right crown kite facets 18 and six quadrilateral left crown kite facets 19, each having sides a, b, c, d. Adjacent right crown star facets 18 and left crown kite facets 19 are mirror images of each other and share a common side (18 side d, and 19 side a). Further, the right crown kite facets 18 have at least side b, c along the girdle and the left crown kite facets 19 have at least side b, c along the girdle.

Turning specifically to FIGS. 3 and 4, the pavilion 14 comprises a culet, a plurality of pavilion main facets 20, at least one lower right half pavilion facet 21, and at least one lower left half pavilion facet 22. In the shown embodiment, the culet is the vertex formed by the plurality of pavilion main facets disposed at the bottom of the gemstone. The plurality of pavilion main facets 20 extend between the girdle and the culet. In a preferred embodiment, the pavilion main facets 20 comprise eight quadrilateral pavilion main facets having sides a, b, c, d, wherein the pavilion main facets 20 have a common vertex formed between sides b, c at the culet and an upper vertex along the girdle formed between sides a, d. The pavilion main facets 20 are arranged at an angle between 41 degrees and 45 degrees with respect to the lower girdle plane 27.

In the shown embodiment, at least one of the lower right half pavilion facet 21 and at least one of the lower left half pavilion facet 22 are positioned between the adjacent pavilion main facets 20. The lower right half pavilion facet 21 being mirror images of the left half pavilion facet 22. Each of at least one of the lower right half pavilion facets 21 and each of at least one of the lower left half pavilion facets 22 comprise a vertex formed between sides a, d along the girdle. Between adjacent pavilion main facets 20, only one of the lower right half pavilion facets 21 and only one of the lower left half pavilion facets 22 have a common vertex formed between sides b, c extending towards the culet.

Turning specifically to FIG. 4, the girdle 13 comprises a plurality of girdle facets comprising a plurality of main girdle facets 23 and a plurality of secondary girdle facets 24. In a preferred embodiment, there are six main girdle facets 23 each main girdle facet having seven sides a-g, and six secondary girdle facets 24, wherein each secondary girdle facet includes six sides a-f. The main girdle facets 23 are arranged adjacent to one of sides of the secondary girdle facets 24.

The plurality of the secondary girdle facets comprising six secondary girdle facets, each secondary girdle facet having six sides and arranged adjacent to one of sides of the main girdle facets 23. Further, each main girdle facet 23 is arranged at a perpendicular angle to the upper girdle plane and the lower girdle plane.

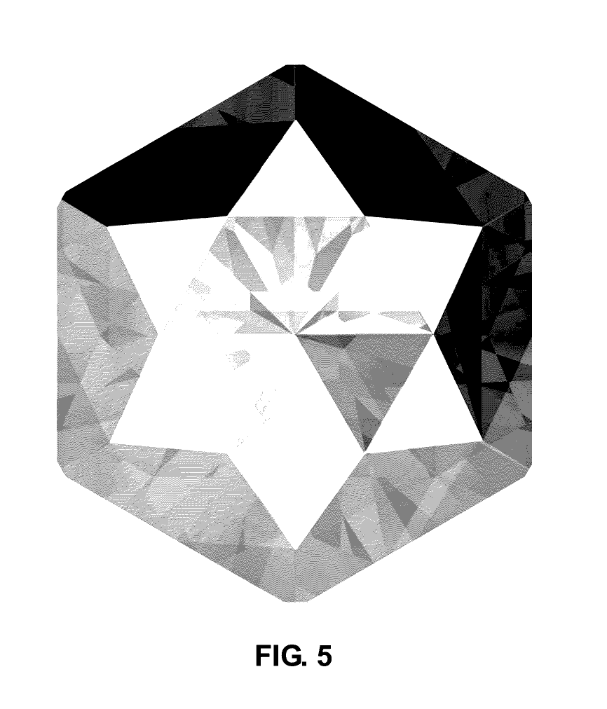

Referring to FIG. 5, there is shown a plan view showing the effect achieved by the unique cut of the gemstone of the present invention when viewed down through the crown in a table up position under a magnifying device. The visual patterns depicted in FIG. 5 are unique to the gemstone of the present invention and can only be accomplished by a gemstone having sixty-one facets created by using the prescribed angles and faceting as described above. The gemstone is configured to display a star when viewed from an overhead angle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A gemstone comprising:
a gemstone comprising a crown, pavilion, and girdle;
a pavilion including a culet, a plurality of pavilion main facets, at least one lower right half pavilion facet, at least one lower left half pavilion facet;
a crown including a table;
a girdle separating the pavilion from the crown; wherein the girdle includes a plurality of girdle facets comprising a plurality of main girdle facets and a plurality of secondary girdle facets;
the plurality of pavilion main facets extending between the girdle and the culet;
at least one of the lower right half pavilion facet and at least one of the lower left half pavilion facet between the adjacent pavilion main facets;
the lower right half pavilion facet being mirror images of the left half pavilion facet;
each of at least one of the lower right half pavilion facets having a side along the girdle;
each of at least one of the lower left half pavilion facets having a side along the girdle,
wherein between adjacent pavilion main facets, only one of the lower right half pavilion facets and only one of the lower left half pavilion facets have a common vertex extending towards the culet.
the plurality of main girdle facets and the plurality of the secondary girdle facets are alternating along the girdle;
a plurality of crown facets comprising a plurality of crown main facets, a plurality of crown star facets, a plurality of right crown kite facets, and a plurality of left crown kite facets;
wherein each of the crown main facets have a vertex along the table;
wherein the each of the crown star facets have a side along the table;
wherein the right crown kite facets and the left crown kite facets have a side along the girdle.

2) The gemstone of claim 1, wherein the gemstone is any of the following: precious gemstone or semi-precious gemstone.

3) The gemstone of claim 1, wherein the gemstone is a diamond.

4) The gemstone of claim 1, wherein the girdle comprises an upper girdle plane and a lower girdle plane, wherein the upper girdle plane and a lower girdle plane are parallel to a horizontal plane;
the plurality of crown facets form an angle between 39 degrees and 41 degrees with respect to the upper girdle plane;
the plurality of pavilion main facets form an angle between 40 degrees and 45 degrees with respect to the lower girdle plane.

5) The gemstone of claim 1, wherein the gemstone is configured to display a star when viewed from an overhead angle.

6) A method of cutting a gemstone, comprising:
forming a crown comprising a table;
forming a pavilion comprising a culet
forming a girdle separating said crown from the pavilion;
forming a plurality of crown facets extending between said girdle and said table;
forming a plurality of pavilion main facets extending between said culet and said girdle;
forming a plurality of half facets extending between said culet and said girdle
forming a plurality of girdle facets extending between the crown and the pavilion.

7) The method of cutting a gemstone of claim 6, wherein:
the crown facets comprise:
six quadrilateral crown main facets, six triangular star crown facets, six quadrilateral right crown kite facets, six quadrilateral left crown kite facets;
wherein each of the crown main facets have a vertex along the table;
wherein each of the crown star facets have a side along the table;
wherein the right crown kite facets and the left crown kite facets have a side along the girdle.

8) The method of cutting a gemstone of claim 6, wherein:
the pavilion facets comprise:
eight quadrilateral main facets, wherein the main facets have a common vertex at the culet.

9) The method of cutting a gemstone of claim 6, wherein:
the pavilion facets comprise:
eight quadrilateral right lower half facets;
eight quadrilateral left lower half facets;
wherein adjacent right lower half facets and left lower facets have a side along the girdle;
wherein adjacent right half pavilion facets and left half pavilion facets are mirror images of each other and share a common side.

10) The method of cutting a gemstone of claim 6, wherein:
the girdle facets comprise:
six main girdle facets, each main girdle facet having seven sides;
six secondary girdle facets, each secondary girdle facet having six sides.

11) A gemstone comprising:
a gemstone comprising a crown, pavilion, and girdle;
a crown including a table comprising six sides forming a hexagonal shape, a plurality of crown main facets, a plurality of crown star facets, a plurality of right crown kite facets, and a plurality of left crown kite facets;
a pavilion including a culet, a plurality of pavilion main facets, a plurality of right half pavilion facets, a plurality of left half pavilion facets;
a girdle comprising a plurality of main girdle facets and a plurality of secondary girdle facets, wherein the girdle separates the pavilion from the crown;
the girdle including an upper girdle plane and a lower girdle plane, wherein the upper girdle plane and a lower girdle plane are parallel to a horizontal plane;
the plurality of crown main facets comprising six quadrilateral crown main facets arranged around the table, each crown main facets having an upper vertex along the table and a lower vertex along the upper girdle plane, and arranged at an angle between 37 degrees and 39 degrees with respect to the upper girdle plane;
the plurality of crown star facets comprising six triangular crown star facets, each crown star facet arranged adjacent to one of sides of the table, and arranged between adjacent crown main facets;
the plurality of right crown kite facets comprising six quadrilateral right crown star facets, each right crown star facet arranged adjacent to one of sides of the crown main facet, and have a side along the girdle;
the plurality of left crown kite facets comprising six left quadrilateral crown kite facets, each left crown kite facet arranged adjacent to one of sides of the crown main facet, and have a side along the girdle;
wherein adjacent right crown star facets and left crown kite facets are mirror images of each other and share a common side;
the plurality of pavilion main facets comprising eight quadrilateral pavilion main facets, each main facet having a common lower vertex at the culet and an upper side along the girdle, and arranged at an angle between 41 degrees and 45 degrees with respect to the lower girdle plane;
the plurality of right half pavilion facets comprising eight quadrilateral right half pavilion facets, each right half pavilion facets arranged adjacent to one of sides of the pavilion main facet;
the plurality of left half pavilion facet comprising eight quadrilateral left half pavilion facets, each left half pavilion facets arranged adjacent to one of sides of the pavilion main facet;
wherein adjacent right half pavilion facets and left half pavilion facets are mirror images of each other and share a common side;
the plurality of main girdle facets comprising six main girdle facets, each main girdle facet having seven sides and arranged adjacent to one of sides of the secondary girdle facets, each main girdle facet arranged at a perpendicular angle to the upper girdle plane and the lower girdle plane;
the plurality of the secondary girdle facets comprising six secondary girdle facets, each secondary girdle facet having six sides and arranged adjacent to one of sides of the main girdle facets.

12) The gemstone of claim 11, wherein the gemstone is configured to display a star when viewed from an overhead angle.
